(19) United States
(12) Patent Application Publication
(10) Pub. No.: US 2010/0028782 A1
(43) Pub. Date: Feb. 4, 2010

(54) METHOD FOR PRODUCING LITHIUM ION CONDUCTIVE GLASS-CERAMIC

(75) Inventor: Yasushi INDA, Sagamihara-shi (JP)

Correspondence Address: DAY PITNEY LLP, 7 TIMES SQUARE, NEW YORK, NY, 10036-7311, US

(73) Assignee: Ohara, Inc., Sagamihara-shi (JP)

(21) Appl. No.: 12/510,774

(22) Filed: Jul. 28, 2009

(30) Foreign Application Priority Data
Jul. 29, 2008 (JP) 2008-195444

(51) Int. Cl. H01M 6/18

(52) U.S. Cl. 429/305

(57) ABSTRACT

The present invention provides a method for stably producing a glass-ceramics having chemical stability and high lithium ion conductivity without pores inhibiting lithium ion conduction at high yield. The method includes heat-treating a glass to crystallize at an increasing rate of crystallization starting temperature of 5° C./h to 50° C./h.

### CROSS-REFERENCE TO RELATED APPLICATION

This application is based upon and claims the benefit of priority from the prior Japanese Patent Application No. 2008-195444, filed on Jul. 29, 2008, the entire contents of which are incorporated herein by reference.

### BACKGROUND OF THE INVENTION

1. Field of the Invention

The present invention relates to a method for producing a lithium ion conductive glass-ceramics having high ion conductivity and chemical stability.

2. Description of the Related Art

It has been pointed out that conventional lithium ion batteries have potential danger due to use of liquid organic electrolytes. To solve the problem, lithium ion conductive solid electrolytes composed of inorganic solids have been studied. For such a solid electrolyte material, lithium ion conductive glass-ceramics disclosed in Japanese Patent Application Laid-Open Nos. 11-157872 and 2000-34134 have been known.

Lithium ion conductive glass-ceramics are prepared by heat-treating raw glass of a specific composition to precipitate crystalline in the glass, and have almost no pore therein, compared with ceramics such as those prepared by sintering powders. Such a lithium ion conductive glass-ceramics is thus characterized by having better ion conductivity than a lithium ion conductive oxide ceramics, as it is free from inhibition of ion conduction by pores.

Ion conductivity and denseness of the glass-ceramics, which also depend on a composition and uniformity of the glass, are largely varied according to heat-treating conditions under which a raw glass is crystallized. For the lithium ion conductive glass-ceramics, particularly compared with a general crystallized glass, when crystalline precipitated from a raw glass have a specific gravity and a thermal expansivity largely different from those of the raw glass, the glass-ceramics suffers large distortion in crystallization and is often broken. Further, in many cases, the lithium ion conductive glass-ceramics has more pores generated therein than a glass-ceramics ideally produced from a raw glass of the same composition, although the number of pores is much smaller than that of ceramics, as shown by observation of a state after crystallization, and exhibits a lithium ion conductivity lower than the original ion conductivity of a crystalline thereof.

As described above, it is difficult to stably produce a glass-ceramics having high lithium ion conductivity at high yield.

### SUMMARY OF THE INVENTION

An object of the present invention is to provide a method for stably producing a glass-ceramic having chemical stability and high lithium ion conductivity at high yield.

The present inventors have investigated to solve the problems, and found that specific heat-treatment conditions for crystallization make it possible to stably produce a glass-ceramics having chemical stability and high lithium ion conductivity at high yield, and thereby accomplished the present invention. The present invention includes:

(1) a method for producing a lithium ion conductive glass-ceramic including heat-treating a glass to crystallize, wherein an increasing rate of crystallization starting temperature in the heat-treatment for crystallization is 5° C./h to 50° C./h;
(2) the method for producing a lithium ion conductive glass-ceramic according to (1), wherein the highest temperature in the heat-treatment for crystallization is 800 to 1,000° C.;
(3) the method for producing a lithium ion conductive glass-ceramic according to (1) or (2), wherein the glass has a thickness of not more than 10 mm;
(4) the method for producing a lithium ion conductive glass-ceramics according to any of (1) to (3), wherein the glass is a plate having a value of S^{1/2}·t⁻¹ of 10 or more and less than 500, where S is an area of a main surface and t is a thickness;
(5) the method for producing a lithium ion conductive glass-ceramics according to any of (1) to (4), wherein the glass is placed between ceramic setters in the heat-treatment for crystallization;
(6) the method for producing a lithium ion conductive glass-ceramics according to any of (1) to (5), wherein a breadth of a temperature distribution in a furnace used for the heat-treatment of the glass is not more than 20° C. at a highest temperature in the heat-treatment for crystallization;
(7) the method for producing a lithium ion conductive glass-ceramic according to any of (1) to (6), wherein the glass includes a ZrO₂ component in an amount of 0.5% to 2.5% by mass based on oxides;
(8) The method for producing a lithium ion conductive glass-ceramics according to any of (1) to (7), wherein the heat-treatment for crystallization forms a crystalline phase of Li_{1+X+Z}M_{X}(Ge_{1-Y}Ti_{Y})_{2-X}P_{3-Z}Si_{Z}O₁₂ (0.6≧X>0, 0.8>Y≧0.2, 0.5≧Z≧0, M=Al, Ga) in the glass;
(9) the method for producing a lithium ion conductive glass-ceramics according to any of (1) to (8), wherein the glass includes:
Li₂O component, 3.5% to 5.0%;
P₂O₅ component, 50% to 55%;
GeO₂ component, 10% to 30%;
TiO₂ component, 8% to 22%; and
M₂O₃ component, 5% to 12%, where M is one or two elements selected from Al and Ga, represented by mass percentages based on oxides;
(10) the method for producing a lithium ion conductive glass-ceramics according to any of (1) to (9), wherein the glass further includes:
SiO₂ component, 0% to 2.5% by mass based on oxides; and
(11) a method for producing a solid electrolyte for a lithium battery, including the steps of lapping and polishing a lithium ion conductive glass-ceramics produced by the method according to any of (1) to (10).

According to the present invention, a chemically stable glass-ceramics that does not break in crystallization, is dense with no pore, and has high lithium ion conductivity can be stably produced at high yield.

### BRIEF DESCRIPTION OF THE DRAWING

FIG. 1 shows a method of determining a crystallization starting temperature (Tx) from a result of a differential thermal measurement.

### DESCRIPTION OF THE PREFERRED EMBODIMENTS

The present inventors have studied and found the followings.

First, when an increasing rate of a crystallization starting temperature is faster than 50° C./h, crystalline precipitate heavily and grow fast to cause large distortion in a glass, which is a cause of break of the glass during a crystallization step.

Next, when an increasing rate of crystallization starting temperature is slower than 5° C./h, many crystal nuclei are generated to precipitate many microcrystals. These microcrystals glow slowly to cause little distortion in a raw glass. There are thus few cases where glass breaks in the heat-treatment, compared with glass treated at a fast increasing rate of temperature. However, when most of a raw glass become crystal nuclei to leave a small glass part, these crystal nuclei have to glow in an insufficient glass matrix less than a required amount for glowing, resulting in pores generated in a grown crystal grain boundary to decrease denseness of a crystallized glass.

From these findings, in the step of heat-treating a prepared raw glass of a lithium ion conductive glass-ceramics for crystallization of the present invention, an increasing rate of crystallization starting temperature is set to 5° C./h to 50° C./h.

To achieve more effects of controlling generation of large distortion in the raw glass, the increasing rate is preferably not higher than 45° C./h, and more preferably not higher than 40° C./h. To achieve more effects of increasing denseness of a crystallized glass, the increasing rate is preferably not lower than 7° C./h, and more preferably not lower than 10° C./h.

In the present invention, the “crystallization starting temperature” is determined by subjecting a glass to a differential thermal measurement at a constant increasing rate of temperature with a thermal analyzer and calculating a starting temperature of an exothermic peak derived from crystallization. Examples of the thermal analyzer include STA-409 manufactured by NETSZCH.

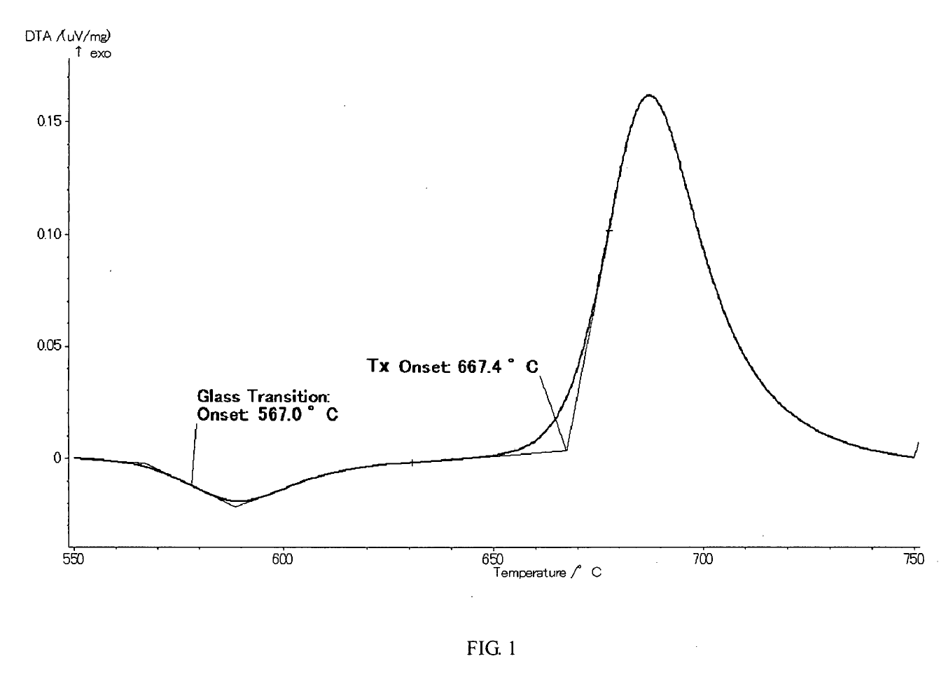

In measuring a crystallization starting temperature (Tx), a glass is crushed into pieces of about 0.5 mm size to be used as a sample. The sample is subjected to a differential thermal measurement at an increasing rate of 10° C./min from a room temperature to 1000° C. with a thermal analyzer, whereby an endothermic/exothermic peak derived from glass transition and an exothermic peak derived from crystallization can be measured. From the measured peak, a starting temperature of the exothermic peak derived from crystallization, or a crystallization starting temperature (Tx) of the glass can be determined. The starting temperature of the exothermic peak is defined as a cross point temperature of tangent lines of the base line and the peak curve as shown in FIG. 1.

When the highest temperature of the heat-treatment for crystallization is lower than 800° C., crystalline contributing to lithium ion conduction glow insufficiently and the resulting glass-ceramics tends to have lower lithium ion conductivity. To increase certainty of high lithium ion conductivity, the highest temperature is preferably not lower than 800° C., more preferably not lower than 840° C., and even more preferably not lower than 860° C. When the highest temperature is over 1000° C., a crystal phase contributing to lithium ion conduction is decomposed and the resulting glass-ceramics tends to have lower lithium ion conductivity. To increase certainty of high lithium ion conductivity, the temperature is preferably not higher than 1000° C., more preferably not higher than 960° C., and even more preferably not higher than 920° C.

A raw glass before subjected to the heat-treatment for crystallization has a coefficient of thermal expansion greatly differing form that of a precipitated crystallization. A thick glass may thus cause different heat histories between a deeper part and a part near the surface of the glass during the heat-treatment for crystallization to provide large distortion in the glass. Such a glass is easy to break. To produce a glass-ceramics having no crack without breaking, a thickness of a raw glass is preferably not more than 10 mm. To produce a glass-ceramics having no crack without breaking more surely, the thickness is more preferably not more than 5 mm, and even more preferably not more than 2 mm. From the viewpoints of ease of molding and mechanical strength, the thickness of a raw glass is preferably not less than 0.4 mm.

To achieve uniform heat transfer in subjecting a glass to crystallization and to provide good workability for processing into a form available for lithium battery applications to the glass subjected to crystallization, a raw glass is preferably in a plate form having an area of a main surface S and a thickness t. To provide a glass-ceramic having no crack without breaking, a value of S^{1/2}·t⁻¹ is preferably not less than 10, more preferably not less than 15, and even more preferably not less than 20. To decrease deflection of the glass in the heat-treatment for crystallization, the value of S^{1/2}·t⁻¹ is preferably less than 500, more preferably less than 400, and even more preferably less than 250.

In the heat-treatment for crystallization of a raw glass, the raw glass is preferably placed between ceramic setters to keep a form of the raw glass during the heat-treatment for crystallization. The setter is preferably composed of quarts, alumina, zirconia, sapphire, boron nitride or the like.

To decrease possibility of break and deformation in the heat-treatment for crystallization, a breadth of a temperature distribution in a furnace used to heat-treat a raw glass at the point of reaching the highest temperature of the heat-treatment for crystallization is preferably not more than 20° C. To achieve more effects on deformation and uniformity of ion conductivity, the breadth is preferably not more than 15° C., and even more preferably not more than 10° C.

A breadth of a temperature distribution in a furnace is measured with universal thermal history sensors (Referthermo L1), which are reference materials available from JFCC (Japan Fine Ceramics Center), by arranging these sensors in a three dimensional manner at 100 mm interval within a useful volume and heat-treating them. According to conditions for evaluating a heat-treatment defined in the user's manual of Referthermo, a furnace to be measured is run in the air under conditions of an increasing rate of 200° C./h, a hold time of 2 h and a decreasing rate of 300° C./h. Referthermos cooled to a room temperature are measured for length with a micrometer. Referencing a length-temperature comparison table identified for each lot, a temperature of a place at which a Referthermo is placed is calculated. Highest and lowest temperatures among all temperatures indicated by Referthermos placed in a useful volume of the furnace are used to calculate a breadth of a temperature distribution by deducting the lowest temperature from the highest temperature.

### [Raw Glass]

Next, the raw glass will be described. Any glass can be used as long as it generates lithium ion conductive crystalline by a heat-treatment to produce a lithium ion conductive glass-ceramics, including sulfide glass and oxide glass produced from, Li₂S, P₂S₅, and the like. The oxide glass is advantageous, because it is stable in the air and easy to handle. A glass forming a crystal phase of Li_{1+X+Z}M_{X}(Ge_{1-Y}Ti_{Y})_{2-X}P_{3-Z}Si_{Z}O₁₂ (0.6≧X>0, 0.8>Y≧0.2, 0.5≧Z≧0, M=Al, Ga) is particularly preferred, because the glass has high lithium ion conductivity after crystallization.

A composition of the glass forming a crystal phase of Li_{1+X+Z}M_{X}(Ge_{1-Y}Ti_{Y})_{2-X}P_{3-Z}Si_{Z}O₁₂ (0.6≧X>0, 0.8>Y≧0.2, 0.5≧Z≧0, M=Al, Ga) will be described. The composition of the glass can be shown by mass percentage based on oxides. As used herein, the “based on oxides” refers to a way of showing composition of ingredients in a glass based on the assumption that raw materials such as oxides and nitrates for components of the glass are fully decomposed in melting into oxides. The “mass percentage based on oxides” represents an amount of each ingredient in the crystallized glass based on the total mass of generated oxides as 100% by mass.

Restriction of an amount of ZrO₂ component particularly within the range of 0.5% to 2.5% in the glass can provide a raw glass that has high stability and is capable of achieving high lithium ion conductivity. A glass containing a ZrO₂ component in an amount of less than 0.5% produces decreased amount of crystal nucleus, and thus an operation temperature for crystallization required to achieve high ion conductivity will be increased. Although it is possible to increase the operation temperature to achieve high ion conductivity, high operation temperature causes excess growth of crystalline, resulting in generation of cracks and internal pores. A glass containing a ZrO₂ component in an amount of more than 2.5% has increased melt-resistance to require higher temperature for melting. The glass also has high possibility to devitrify and is hard to become a glass state. Such a raw material cannot stably produce a glass. To achieve a dense glass-ceramics having high ion conductivity, the lower limit of the amount of ZrO₂ component is preferably 0.7%, and more preferably 0.9%. The upper limit is preferably 2.1%, and more preferably 2%, because the higher content leads to the higher possibility to devitrify.

In general, thermal stability of a glass is assessed by a value of difference Tx−Tg (Tx [° C.] is a crystallization temperature of the glass, and Tg [° C.] is a glass transition temperature). A glass having a larger value has better thermal stability. The raw glass of the glass-ceramics of the present invention having the above-described composition has significantly increased thermal stability, with a value of Tx−Tg not less than 70° C. The value can reach the maximum value of 160° C., although such a raw glass has slightly inferior lithium ion conductivity. In a more preferred aspect considering lithium ion conductivity and the like in an integrated manner, the value can reach not less than 72° C., and in even more preferred aspect, the value can reach not less than 74° C.

The Li₂O component provides a Li⁺ ion carrier and is useful to impart lithium ion conductivity. To achieve good lithium ion conductivity, the lower limit of an amount of Li₂O component is preferably 3.5%, more preferably 3.7%, and even more preferably 3.9%. The upper limit of the amount is preferably 5.0%, more preferably 4.8%, and even more preferably 4.6%, because the higher content leads to the higher possibility to devitrify.

The P₂O₅ component is useful to form a glass and is one of constituent elements of the crystal phase. A raw glass containing the P₂O₅ component in an amount of less than 50% has high melting temperature, resulting in properties hard to become a glass state. Such a raw material hard to become a glass state is difficult to be formed in a glass state at high temperature, particularly to provide a glass of a large bulk form (e.g., 200 cm³ or more). The lower limit of the content is thus preferably 50%, more preferably 50.5%, and even more preferably 51%. A raw glass containing the P₂O₅ component in an amount of more than 55% hardly forms the crystal phase in the heat-treatment (crystallization), and it is difficult to achieve desired characteristics. The upper limit of the content is thus preferably 55%, more preferably 54.5%, and even more preferably 54%.

Relatively small amount of the ZrO₂ component with respect to an amount of the P₂O₅ component serving as a glass former causes insufficient generation of crystal nucleus to produce not small but large crystalline, resulting in a glass-ceramics having low ion conductivity and low denseness. Thus, a ratio of mass percentages of the P₂O₅ component to the ZrO₂ component, represented by P₂O₅/ZrO₂, is preferably not less than 25, more preferably not less than 30, and even more preferably not less than 35.

A raw glass containing relatively large amount of the ZrO₂ component with respect to an amount of the P₂O₅ component has increased melting point and high possibility to devitrify in molding a glass. Thus, the above ratio is preferably not more than 100, more preferably not more than 90, and even more preferably not more than 75.

The GeO₂ component is useful to form a glass and is a possible component to be one of constituent elements of the lithium ion conductive crystal phase. A raw glass containing the component in an amount of less than 10% is hard to become a glass state and hard to form the crystal phase, resulting in difficulty of achieving high lithium ion conductivity. The lower limit of the content is thus preferably 10%, more preferably 11%, and even more preferably 11.5%. A raw glass containing the component in an amount of more than 30% results in a glass-ceramic having low ion conductivity and low durability. The upper limit of the content is thus preferably 30%, more preferably 28%, and even more preferably 26%.

The TiO₂ component is useful to form a glass and is a possible component to be one of constituent elements of the lithium ion conductive crystal phase. A raw glass containing the component in an amount of less than 8% is hard to become a glass state and hard to form the crystal phase, resulting in difficulty of achieving high lithium ion conductivity. The lower limit of the content is thus preferably 8%, more preferably 9%, and even more preferably 10%. A raw glass containing the component in an amount of more than 22% has high possibility to devitrify. The upper limit of the content is thus preferably 22%, more preferably 21%, and even more preferably 20%.

The M₂O₃ component (wherein, M is one or two elements selected from Al and Ga) can increase thermal stability of a raw glass and also has effects of increasing lithium ion conductivity due to Al³⁺ and/or Ga³⁺ ions replaced as solid in the crystal phase. The lower limit of the content is thus preferably 5%, more preferably 6%, and even more preferably 7%. However, a raw glass containing the component in an amount of more than 12% has inferior thermal stability and provides a glass-ceramics having decreased lithium ion conductivity. The upper limit of the content is thus preferably 12%, more preferably 11%, and even more preferably 10%.

The SiO₂ component can be optionally added to a raw glass, since it can improve meltability and thermal stability of the raw glass and also contributes to increasing lithium ion conductivity due to a Si⁴⁺ ion replaced as solid in the crystal phase. However, a raw glass containing the component in an amount of more than 2.5% tends to generate cracks in crystallization, resulting in decreased lithium ion conductivity. To keep good lithium ion conductivity, the content is preferably not more than 2.5%, more preferably not more than 2.2%, and even more preferably not more than 2%.

The M′₂O₃ component (wherein, M′ is one or more elements selected from the group consisting of In, Fe, Cr, Sc, Y, La, Ce, Pr, Nd, Sm, Eu, Gd, Tb, Dy, Ho, Er, Tm, Yb and Lu) has effects of improving meltability and thermal stability of a raw glass and can be contained up to 5% in total. However, since raw materials for the component are distributed in the market at very high price, the component is preferably substantially not contained.

To further improve meltability of the glass, B₂O₃, As₂O₃, Sb₂O₃, Ta₂O₅, CdO, PbO, MgO, CaO, SrO, BaO, ZnO, and the like may be added. However, an amount thereof should be limited to not more than 3%. A raw glass containing more than 3% of them produces a glass-ceramic having significantly decreased conductivity according to the amount added.

The raw glass can be produced according to the following method. Briefly speaking, starting materials are weighed and uniformly mixed. The mixture is then placed in a platinum pot and heated to melt in an electric furnace. A temperature is raised to 1200 to 1400° C. and held at that temperature for 2 hours or more to melt the mixture. The molten glass is cast on an iron plate to give a glass plate. The glass plate may further be subjected to cutting, lapping, polishing, and the like, according to need.

A lithium ion conductive glass-ceramics produced by the method of the present invention can have a lithium ion conductivity of not less than 5.0×10⁻⁵ S·cm⁻¹, more preferably not less than 8.0×10⁻⁵ S·cm⁻¹, and even more preferably not less than 1.0×10⁻⁴ S·cm⁻¹.

To use the glass-ceramics produced by the method of the present invention as a solid electrolyte for lithium batteries such as a lithium ion secondary battery and a lithium primary battery, it may be processed into a form fitting to a battery to be produced. The glass-ceramics is preferably processed into a thin plate shape. A method of processing may be known methods of lapping and polishing generally used for glass and glass-ceramics. For example, a glass-ceramic plate may be ground with pellets of around #1000 using a double-side work machine, and polished with a urethane polishing pad while supplying a polishing liquid.

When a processed glass-ceramics is used as a solid electrolyte for lithium batteries, to ensure mechanical strength required for battery use, the lower limit of a thickness of the glass-ceramics is preferably 0.5 μm, more preferably 1 μm, and even more preferably 5 μm. To achieve good lithium ion conductivity, the upper limit of the thickness is preferably 1000 μm, more preferably 500 μm, and even more preferably 300 μm.

The solid electrolyte for lithium batteries is provided with a positive electrode material and a negative electrode material arranged at both sides. These materials and known current collector are arranged and packed by a known method to produce a battery such as a lithium primary battery or a lithium ion secondary battery.

For a positive electrode material of the lithium primary battery, those capable of storing lithium can be used, including transition metal compounds and carbon materials. For example, a transition metal oxide containing at least one element selected from manganese, cobalt, nickel, vanadium, niobium, molybdenum and titanium, graphite and carbon can be used.

For a negative electrode material of the lithium primary battery, those capable of releasing lithium can be used, including metal lithium, a lithium-aluminium alloy and a lithium-indium alloy.

For an active material used in a positive electrode material of the lithium secondary battery, transition metal compounds capable of storing/releasing lithium ion can be used. Examples of the transition metal compound that can be used include transition metal oxides containing at least one element selected from manganese, cobalt, nickel, vanadium, niobium, molybdenum and titanium.

For an active material used in a negative electrode material of the lithium secondary battery, preferably used are metal lithium, alloys capable of storing/releasing lithium such as a lithium-aluminium alloy and a lithium-indium alloy, transition metal oxides such as titanium and vanadium, and carbon materials such as graphite.

Addition of the same material as the glass-ceramics contained in a solid electrolyte to positive and negative electrodes is more preferred, because it imparts ion conductivity to the electrodes. Electrodes and the electrolyte containing the same material have the same mechanism of ion transfer, and thus ion transfer between the electrolyte and electrodes smoothly occurs, whereby a battery having higher output/capacity can be provided.

The solid electrolyte for lithium batteries produced by the method of the present invention is also preferably used as an electrolyte for lithium-air batteries. For example, a lithium-air battery containing lithium metal as a negative electrode, a porous carbon material as a positive electrode and the solid electrolyte of the present invention arranged therein can be produced.

### Examples

A method for producing the lithium ion conductive glass-ceramics according to the present invention will be specifically described below with Examples. It should be noted that the present invention is not limited to these Examples and can be appropriately modified within the range that does not change the scope of the invention.

Starting materials used were H₃PO₄, Al(PO₃)₃, and Li₂CO₃ (Nippon Chemical Industrial Co., Ltd.), SiO₂ (Nitchitsu Co., Ltd.), TiO₂ (Sakai Chemical Industry Co., Ltd.), GeO₂ (Sumitomo Metal Mining Co., Ltd.) and ZrO₂ (Nippon Denko Co., Ltd.). These materials in such amounts as constructing a composition shown in Table 1 represented by mol % based on oxides were uniformly mixed and placed in a platinum pot. In an electric furnace, the mixture was heated to melt under stirring for 3 hours at 1350° C. to make a molten glass.

The molten glass was poured into a metal mold made of INCONEL (trade name) 600, which was heated to 300° C., through a platinum pipe attached to the pot while heating the molten glass. The glass was allowed to cool until a surface temperature of the glass became 600° C. or lower. The cooled glass was placed in an electric furnace heated to 550° C. and gradually cooled to a room temperature to make a glass block having relieved thermal stress.

The resultant glass was crushed to pieces of about 0.5 mm. These pieces were subjected to a differential thermal measurement at an increasing rate of 10° C./min from a room temperature to 1000° C. with a thermal analyzer STA-409 (manufactured by NETSZCH) to calculate a starting temperature of an exothermic peak due to crystallization. The point was considered as a crystallization starting temperature (Tx).

Compositions and measured crystallization starting temperatures (Tx) of glass prepared are shown in Table 1.

TABLE 1

| | Composition (% by mass) | | | | | | | | |
|---|---|---|---|---|---|---|---|---|---|
| | Li₂O | Al₂O₃ | Ga₂O₃ | SiO₂ | P₂O₅ | TiO₂ | GeO₂ | ZrO₂ | Tx (° C.) |
| No. 1 | 4.2 | 8.0 | 0 | 1.0 | 52.3 | 13.2 | 20.1 | 1.2 | 667 |
| No. 2 | 4.1 | 0 | 7.8 | 1.2 | 53.6 | 15.2 | 18.2 | 0.9 | 670 |

The resultant glass block was cut into forms, such as a disc of 25.7 mm diameter and 1 mm thickness and a plate of 51.5 mm squared and having 1 mm thickness. A cut glass was placed between alumina setters and subjected to a heat-treatment for crystallization up to 890° C. for 12 hours. Various increasing rates of crystallization starting temperature were used to crystallize glass. X-ray diffractometry showed that the crystallized glass-ceramic had a crystal phase of Li_{1+X+Z}M_{X}(Ge_{1-Y}Ti_{Y})_{2-X}P_{3-Z}Si_{Z}O₁₂ (0.6≧X>0, 0.8>Y≧0.2, 0.5≧Z≧0, M=Al, Ga).

The crystallized glass-ceramics was ground and polished on both surfaces to prepare a sample for measuring an ionic conductivity and observing a microstructure.

Au electrodes were attached on both sides of the glass-ceramic sample by sputtering gold targets with a quick coater available from Sanyu Electron Co., Ltd. The glass-ceramic sample was measured for a complex impedance of an alternating current between two terminals with an impedance analyzer SI-1260 (Solartron) to calculate a lithium ion conductivity at 25° C.

For a sample broken in the heat-treatment for crystallization, only a broken piece having a diameter of 10 mm or more was used to calculate a lithium ion conductivity similarly as above.

The glass-ceramic sample was subjected to a microstructure observation on a polished surface to determine the presence or absence of pores having a diameter of 0.1 μm or more with an electron microscope S-3000N (manufactured by Hitachi, Ltd.).

Table 2 shows crystallization starting temperatures, increasing rates of crystallization starting temperatures (in the Table, simply referred to as increasing rates), maximum temperatures of the heat-treatment for crystallization (in the Table, simply referred to as crystallization maximum temperatures), the presence or absence of cracks after crystallization, ionic conductivities at 25° C. and the presence or absence of pores according to a microstructure observation of Examples and Comparative Examples. The presence of cracks after crystallization is represented by a percentage of plates having cracks among ten plates. The ion conductivity is an average value calculated from measured conductivities of samples (n=10).

TABLE 2

| | | | Comparative | Comparative |
|---|---|---|---|---|
| | Example 1 | Example 2 | Example 1 | Example 2 |
| Glass composition | No1 | No2 | No1 | No2 |
| The number of samples | 10 | 10 | 10 | 10 |
| Crystallization starting | 665° C. | 670° C. | 665° C. | 670° C. |
| temperature | | | | |
| Size (mm) | Φ25.4 × 1t | □51.5 × 1t | Φ25.4 × 5t | □51.5 × 1t |
| S^{1/2} · t⁻¹ | 22.5 | 51.5 | 4.5 | 51.5 |
| Increasing rate (° C./h) | 10° C./h | 40° C./h | 3° C./h | 100° C./h |
| Crystallization | 880° C. | 880° C. | 880° C. | 880° C. |
| maximum temperature | | | | |
| Generation of cracks | 0 | 0 | 60 | 100 |
| (%) | | | | |
| Generation of pores (%) | 0 | 0 | 100 | 100 |
| Ion conductivity | 1.2 × 10⁻⁴ | 1.0 × 10⁻⁴ | 1.4 × 10⁻⁴ | 0.8 × 10⁻⁴ |
| (average) (Scm⁻¹) | | | | |

*Φ represents a diameter of a circle, and □ represents a length of a side of a square.

In Examples 1 and 2, no crack or pore was generated, and glass-ceramics could be produced at good yield. In Comparative Examples 1 and 2, which were cases of slower and faster increasing rates for crystallization, respectively, cracks and pores were easily generated. Particularly in Comparative Example employing a faster increasing rate, cracks were observed in all of ten samples.

Glasses of compositions Nos. 1 and 2 prepared in Examples 1 and 2 were subjected to crystallization with three furnaces available from Noritake Co., Ltd., Chugai-Naber, and Yamato Scientific Co., Ltd. These three furnaces were measured for a temperature distribution in a furnace around a maximum temperature for crystallization. Results were 10° C., 15° C., 30° C. for the Noritake furnace, the Chugai-Naber furnace, and the Yamato Scientific furnace, respectively. Glass-ceramics crystallized with these furnaces were measured for ion conductivity and observed for the presence or absence of pores. Results are shown in Table 3.

TABLE 3

| | | | Comparative | Comparative |
|---|---|---|---|---|
| | Example 3 | Example 4 | Example 3 | Example 4 |
| Glass composition | No1 | No2 | No1 | No2 |
| Crystallization starting | 665° C. | 670° C. | 665° C. | 670° C. |
| temperature | | | | |
| Size (mm) | □51.5 × 1t | Φ25.4 × 1t | □51.5 × 1t | Φ25.4 × 1t |
| S^{1/2} · t⁻¹ | 51.5 | 22.5 | 51.5 | 22.5 |
| Increasing rate (° C./h) | 20° C./h | 40° C./h | 10° C./h | 30° C./h |
| Crystallization | 900° C. | 900° C. | 900° C. | 900° C. |
| maximum temperature | | | | |
| Temperature distribution | 10° C. | 15° C. | 35° C. | 35° C. |
| Cracks | Not observed | Not observed | Observed | Not observed |
| Pores | Not observed | Not observed | Observed | Observed |
| Ion conductivity | 1.4 × 10⁻⁴ | 1.2 × 10⁻⁴ | 1.0 × 10⁻⁴ | 1.5 × 10⁻⁴ |
| (average) (Scm⁻¹) | | | | |

*Φ represents a diameter of a circle, and □ represents a length of a side of a square.

In Examples 3 and 4, in which a breadth of a temperature distribution for crystallization were 10 to 15° C., glass was not broken in the treatment for crystallization to produce glass-ceramics having no pore. In cases of a wide temperature distribution as a breadth of 35° C., Comparative Example 3 using a sample having a large size produced a glass-ceramics having cracks and pores. Comparative Example 4 produced a glass-ceramics in which pores were partially generated possibly by partially faster growth of crystalline, while no cracks were observed.

As described above, by controlling an increasing rate of temperature and a temperature distribution for crystallization, a glass-ceramics can be produced at high yield.

This application claims priority from Japanese Patent Application No. 2008-195444, filed Jul. 29, 2008, which is hereby incorporated by reference herein in its entirety.

What is claimed is:

1. A method for producing a lithium ion conductive glass-ceramics comprising heat-treating a glass to crystallize, wherein an increasing rate of crystallization starting temperature in the heat-treatment for crystallization is 5° C./h to 50° C./h.

2. The method for producing a lithium ion conductive glass-ceramics according to claim 1, wherein the highest temperature in the heat-treatment for crystallization is 800 to 1,000° C.

3. The method for producing a lithium ion conductive glass-ceramics according to claim 1, wherein the glass has a thickness of not more than 10 mm.

4. The method for producing a lithium ion conductive glass-ceramics according to claim 1, wherein the glass is a plate having a value of S^{1/2}·t⁻¹ of 10 or more and less than 500, where S is an area of a main surface and t is a thickness.

5. The method for producing a lithium ion conductive glass-ceramics according to claim 1, wherein the glass is placed between ceramic setters in the heat-treatment for crystallization.

6. The method for producing a lithium ion conductive glass-ceramics according to claim 1, wherein a breadth of a temperature distribution in a furnace used for the heat-treatment of the glass is not more than 20° C. at a highest temperature in the heat-treatment for crystallization.

7. The method for producing a lithium ion conductive glass-ceramics according to claim 1, wherein the glass comprises a ZrO₂ component in an amount of 0.5% to 2.5% by mass based on oxides.

8. The method for producing a lithium ion conductive glass-ceramics according to claim 1, wherein the heat-treatment for crystallization forms a crystal phase of Li_{1+X+Z}M_{X}(Ge_{1-Y}Ti_{Y})_{2-X}P_{3-Z}Si_{Z}O₁₂ (0.6≧X>0, 0.8>Y≧0.2, 0.5≧Z≧0, M=Al, Ga) in the glass.

9. The method for producing a lithium ion conductive glass-ceramics according to claim 1, wherein the glass comprises:
Li₂O component, 3.5% to 5.0%;
P₂O₅ component, 50% to 55%;
GeO₂ component, 10% to 30%;
TiO₂ component, 8% to 22%; and
M₂O₃ component, 5% to 12%, where M is one or two elements selected from Al and Ga,
represented by mass percentages based on oxides.

10. The method for producing a lithium ion conductive glass-ceramics according to claim 1, wherein the glass further comprises:
SiO₂ component, 0% to 2.5% by mass based on oxides.

11. A method for producing a solid electrolyte for a lithium battery, comprising the steps of lapping and polishing a lithium ion conductive glass-ceramic produced by the method according to any of claims 1 to 10.
